(19) United States
(12) Patent Application Publication
(10) Pub. No.: US 2010/0200084 A1
(43) Pub. Date: Aug. 12, 2010

(54) PRESSURE CONTROL SYSTEM AND PRESSURE REGULATING VALVE THEREOF

(75) Inventors: Chih-Yen Lin, Taoyuan County (TW); Yu-Chun Ko, Taoyuan County (TW); Chiang-Wen Lai, Taoyuan County (TW)

Correspondence Address: QUINTERO LAW OFFICE, PC, 615 Hampton Dr, Suite A202, Venice, CA, 90291, US

(73) Assignee: NAN YA PCB CORP., Taoyuan County (TW)

(21) Appl. No.: 12/408,997

(22) Filed: Mar. 23, 2009

(30) Foreign Application Priority Data
Feb. 12, 2009 (TW) TW098104429

(51) Int. Cl. F16K 31/122

(52) U.S. Cl. 137/505.11; 137/624.27

(57) ABSTRACT

A pressure control system in provided, including a pressure regulating valve, a throttle valve and a relief valve. The pressure regulating valve includes a valve body and a piston assembly. The valve body has a chamber, wherein the chamber has an inlet and an outlet. The piston assembly, movably disposed in the chamber, includes a first piston and a second piston. The first piston corresponds to the inlet and has a first contact surface. The second piston corresponds to the outlet and has a second contact surface. The first piston and the second piston move simultaneously, and the first contact surface is smaller than the second contact surface. The throttle valve, connected with the pressure regulating valve, is disposed at a side of the outlet of the valve body. The relief valve, connected with the pressure regulating valve, is disposed at a side of the inlet of the valve body.

### CROSS REFERENCE TO RELATED APPLICATIONS

This Application claims priority of Taiwan Patent Application No. 98104429, filed on Feb. 12, 2009, the entirety of which is incorporated by reference herein.

### BACKGROUND OF THE INVENTION

1. Field of the Invention

The invention relates to a pressure control system, and in particular, to a pressure control system comprising a miniaturized pressure regulating valve.

2. Description of the Related Art

Referring to FIG. 1, a conventional pressure regulating valve 10 comprises a valve rod 11, an air-tight pad 13, a diaphragm 15, two springs S, S′ and an adjusting screw 17, all of which are disposed in a chamber. The air-tight pad 13 and the diaphragm 15 are respectively disposed on two opposite ends of the valve rod 11, wherein the air-tight pad 13 is disposed at the inlet end of the chamber to seal the inlet. The springs S, S′ are respectively disposed on two sides of the air-tight pad 13 and the diaphragm 15 to fix the air-tight pad 13 and the diaphragm 15 therebetween and to provide force to the air-tight pad 13 and the diaphragm 15, respectively. The spring S functions as a buffer to prevent vibration, and the force of the spring S′ is adjusted by the adjusting screw 17.

Compressed air flows into the pressure regulating valve 10 (as shown by the arrow in FIG. 1). The pressure of the compressed air in the chamber is applied to the diaphragm 15, and the force of the spring S′ is applied to the diaphragm 15 on the other side of the diaphragm 15. If the pressure of the compressed air applied to the diaphragm 15 is greater than the compressive force of the spring S′, the diaphragm 15 is pressed downward, moving the air-tight pad 13 simultaneously on the other end of the valve rod 11 to seal the inlet. The adjusting screw 17 adjusts the compressive force of the spring S′ to enhance the compressive force of the spring S′. When the compressive force of the spring S′ is greater than the force of the compressed air, the air-tight pad 13 on the other end of the valve rod 11 is pushed upward to be away from the inlet, thereby the compressed air is able to flow from the inlet to the outlet, and before reaching an equilibrium, the compressed air continues to flow into the chamber.

However, the components within the conventional pressure regulating valve require much space such that miniaturization applications are inhibited. Thus, conventional pressure regulating valve are not suitable to be applied to fuel cell systems with minimum volume.

A detailed description is given in the following embodiments with reference to the accompanying drawings.

### BRIEF SUMMARY OF THE INVENTION

Accordingly, the invention provides a pressure control system including a pressure regulating valve, a throttle valve and a relief valve. The pressure regulating valve includes a valve body and a piston assembly. The valve body has a chamber, wherein the chamber has an inlet and an outlet. The piston assembly, movably disposed in the chamber, includes a first piston and a second piston. The first piston corresponds to the inlet and has a first contact surface. The second piston corresponds to the outlet and has a second contact surface. The first piston and the second piston move simultaneously, and the first contact surface is smaller than the second contact surface. The throttle valve, connected with the pressure regulating valve, is disposed at a side of the outlet of the valve body. The relief valve, connected with the pressure regulating valve, is disposed at a side of the inlet of the valve body.

The invention provides a pressure regulating valve including a valve body and a piston assembly. The valve body has a chamber, wherein the chamber has an inlet and an outlet. The piston assembly, movably disposed in the chamber, includes a first piston and a second piston. The first piston corresponds to the inlet and has a first contact surface, and the second piston, connected with the first piston, corresponds to the outlet and has a second contact surface. The first piston and the second piston move simultaneously, and the first contact surface is smaller than the second contact surface

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional pressure regulating valve;

FIGS. 2A and 2B are schematic views of a pressure control system of the invention; and

FIG. 3 is a schematic view showing the force relationships in the pressure control system of the invention.

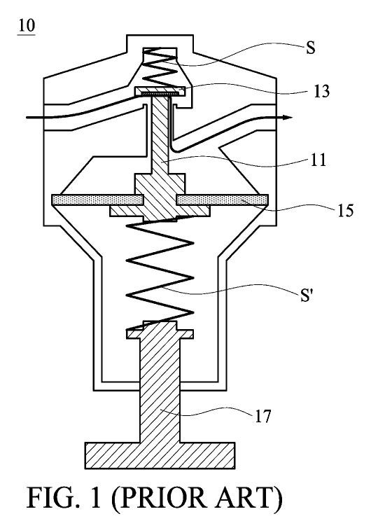

### DETAILED DESCRIPTION OF THE INVENTION

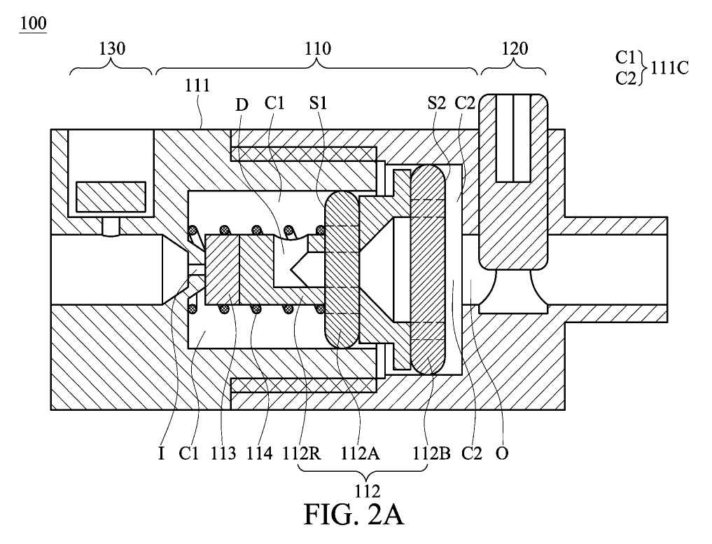

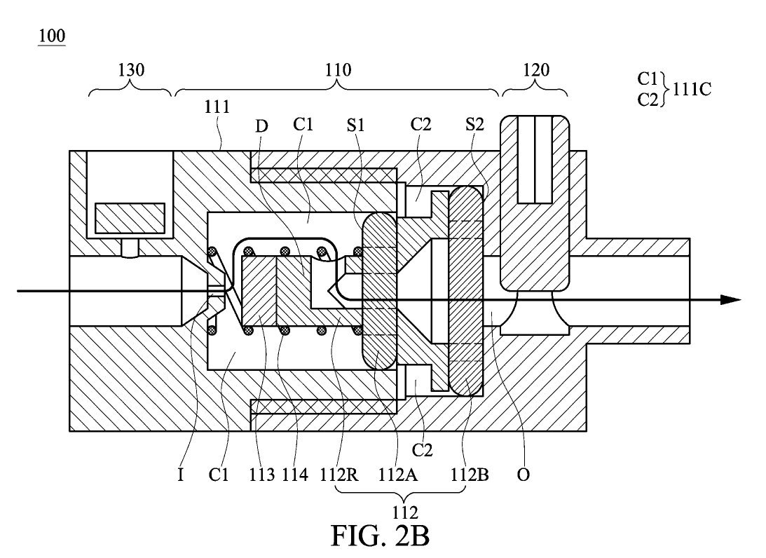

Referring to FIGS. 2A and 2B, the pressure control system 100 controls and regulates pressure of the compressed air. Usually, the pressure control system 100 is applied to a fuel cell system to regulate the pressure of the compressed air to a relatively low volume, such that it is acceptable for the compressed air to enter into a fuel cell. The pressure control system 100 comprises a pressure regulating valve 110, a throttle valve 120 and a relief valve 130, wherein the pressure regulating valve 110 connects with the throttle valve 120 and the relief valve 130.

The pressure regulating valve 110 comprises a valve body 111, a piston assembly 112, an air-tight sealer and an elastic member 114. The valve body 111 has a chamber 111C, and the chamber 111C has an inlet I and an outlet O.

The piston assembly 112 comprises a first piston 112A, a second piston 112B and a connecting member 112R. The first piston 112A has a first contact surface A1 contacting the compressed air, the second piston 112B has a second contact surface A2 contacting the compressed air, and the first surface A1 is smaller than the second surface A2. The first piston 112A and the second piston 112B are respectively disposed on the connecting member 112R. Thereby, the first piston 112A and the second piston A2 are connected.

Additionally, the piston assembly 112 is movably disposed in the chamber 111C. When the piston assembly 112 is disposed in the chamber 111C, the chamber 111C is divided into a first sub-chamber C1 and a second sub-chamber C2. The first sub-chamber C1 communicates with the inlet I, the second sub-chamber C2 communicates with the outlet O, and the first sub-chamber C1 and the second sub-chamber C2 communicate with each other by a passage D within the connecting member 112R. The first piston 112A, corresponding to the inlet I, moves in the first chamber C1, the second piston 112B, corresponding to the outlet O, moves in the second chamber C2, and the first piston 112A and the second piston 112B move simultaneously.

The air-tight sealer 113, connected with the piston assembly 112, is disposed on an end of the connecting member 112R. When the piston assembly 112 moves, the air-tight sealer 13 moves with the piston assembly 112. The piston assembly 112 moves between a first position and a second position. When the piston assembly 112 is in the first position, the air-tight sealer 113 abuts the inlet I and seals the inlet I (as shown in FIG. 2A), and when the piston assembly 112 is in the second position, the air-tight sealer 113 is away from the inlet I and opens the inlet I (as shown in FIG. 2B).

The elastic member 114 is disposed on the connecting member 112R, abutting an inner wall of the chamber 111C and the piston assembly 112. The elastic member 114 applies force on the piston assembly 112 to push the piston assembly 112 toward the outlet O.

The throttle valve 120 is disposed on a side of the outlet O of the chamber 111C, thereby controlling volume of the compressed air flowing out of the outlet O. When the compressed air flows into the chamber 111C, controlling volume of the outflow compressed air, the back pressure within the chamber 111C is controlled.

The relief valve 130 is disposed at a side of the inlet I of the chamber 11C. When the pressure of the compressed air exceeds a certain volume, the relief valve 130 automatically opens. Before entering the chamber 111C through the inlet I, the compressed air is partially released to protect the air source.

The compressed air enters the first sub-chamber C1 through the inlet I, passes the passage D of the connecting member 112R, flows into the second sub-chamber, and then is exhausted from the outlet O (as shown in FIG. 2B).

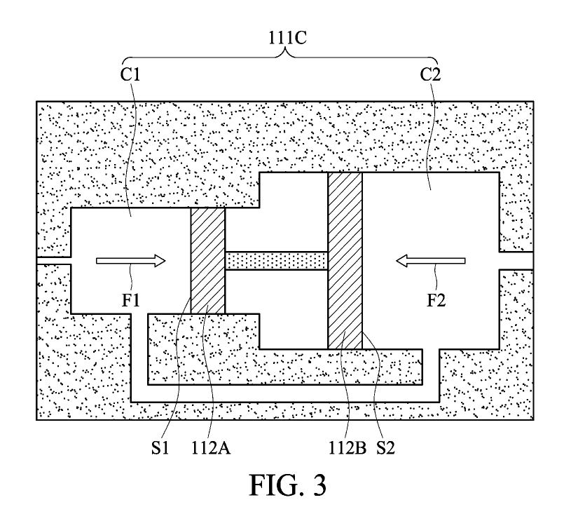

Referring to FIG. 3, adjusting the throttle valve 120 generates a back pressure P in the chamber 111C. In the first sub-chamber C1, the compressed air applies a first force F1 to the first contact surface A1, and in the second sub-chamber C2, the compressed air applies a second force F2 to the second contact surface A2. The first contact surface S1 has a first area A1, and the second contact surface S2 has a second area A2. Because the first sub-chamber C1 communicates with the second sub-chamber C2, the back pressures P in the first sub-chamber C1 and the second sub-chamber C2 are the same.

If P=F/A, then F1=PxA1, and F2=PxA2. Because the back pressures P are the same, when the second area A2 is larger than the first area A1, the second force F2 is greater the first force F1, pushing the piston assembly 112 toward the inlet I. On the contrary, if the back pressure P is released by adjusting the throttle valve 120, the compressed air is able to push the piston assembly 112 from the inlet, moving the piston assembly 112 toward the outlet O.

It should be noted that the force of the elastic member 114 provided is omitted to clearly describe the relationship between the first force F1 and the second force F2. The disposition of the elastic member 114 helps push the piston assembly 112 toward the outlet O. Therefore, if the pressure at the inlet I is lower than usual, the piston assembly 112 will still be able to move. Note that when designing the overall structure of the pressure regulating valve 110, the force of the elastic member 114 is also an important fact. In other words, the second force F2 must be greater than the first force F1 plus the force of the elastic member 114 in order to push the piston assembly 112 toward the inlet I.

The pressure regulating valve 110 of the pressure control system 100 controls the moving direction of the piston assembly 112 by adjusting the back pressure within the chamber 111C, changing the outflow pressure of the compressed air. When the outlet O is closed, the rise of the pressure of the compressed air at the outlet O stops when it reaches a certain value. The size of the pressure control system 100 of the invention is minimized to be directly connected with a small-sized fuel cell, making assembly more convenient.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pressure control system, comprising:
a pressure regulating valve, comprising:
a valve body having a chamber, wherein the chamber has an inlet and an outlet; and
a piston assembly movably disposed in the chamber, comprising:
a first piston corresponding to the inlet and having a first contact surface; and
a second piston connected with the first piston, corresponding to the outlet and having a second contact surface,
wherein the first piston and the second piston move simultaneously, and the first contact surface is smaller than the second contact surface.

2. The pressure control system as claimed in claim 1, wherein the pressure regulating valve further comprises an air-tight sealer connected with the piston assembly, and when the piston assembly moves, the air-tight sealer accordingly moves.

3. The pressure control system as claimed in claim 2, wherein the piston assembly moves between a first position and a second position, and when the piston assembly is in the first position, the air-tight sealer abuts the inlet and seals the inlet, and when the piston assembly is in the second position, the air-tight sealer is away from the inlet.

4. The pressure control system as claimed in claim 2, wherein the piston assembly further comprises a connecting member connecting the first piston with the second piston.

5. The pressure control system as claimed in claim 4, wherein the air-tight sealer is disposed at an end of the connecting member.

6. The pressure control system as claimed in claim 4, wherein the pressure regulating valve further comprises an elastic member disposed on the connecting member and abutting an inner wall of the chamber and the piston assembly.

7. The pressure control system as claimed in claim 1, wherein the piston assembly divides the chamber into a first sub-chamber communicating with the inlet, and a second sub-chamber communicating with the outlet, and the first sub-chamber and the second sub-chamber communicate with each other.

8. The pressure control system as claimed in claim 7, wherein the piston assembly further comprises a connecting member connecting the first piston with the second piston, and the connecting member has a passage communicating the first sub-chamber with the second sub-chamber.

9. The pressure control system as claimed in claim 1, wherein the pressure regulating valve further comprises an elastic member disposed in the chamber abutting an inner wall of the chamber and the first piston.

10. The pressure control system as claimed in claim 1, further comprising a throttle valve connected with the pressure regulating valve and disposed on a side of the outlet of the valve body.

11. The pressure control system as claimed in claim 1, further comprising a relief valve connected with the pressure regulating valve and disposed on a side of the inlet of the valve body.

12. A pressure regulating valve, comprising:
a valve body having a chamber, wherein the chamber has an inlet and an outlet; and
a piston assembly movably disposed in the chamber, comprising:
a first piston corresponding to the inlet and having a first contact surface; and
a second piston connected with the first piston, corresponding to the outlet and having a second contact surface,
wherein the first piston and the second piston move simultaneously, and the first contact surface is smaller than the second contact surface.

13. The pressuring regulating valve as claimed in claim 12, further comprising an air-tight sealer connected with the piston assembly, wherein when the piston assembly moves, the air-tight sealer accordingly moves.

14. The pressure regulating valve as claimed in claim 13, wherein the piston assembly moves between a first position and a second position, and when the piston assembly is in the first position, the air-tight sealer abuts the inlet and seals the inlet, and when the piston assembly is in the second position, the air-tight sealer is away from the inlet.

15. The pressure regulating valve as claimed in claim 13, wherein the piston assembly further comprises a connecting member connecting the first piston with the second piston.

16. The pressure regulating valve as claimed in claim 15, wherein the air-tight sealer is disposed at an end of the connecting member.

17. The pressure regulating valve as claimed in claim 15, wherein the pressure regulating valve further comprises an elastic member disposed on the connecting member and abutting an inner wall of the chamber and the piston assembly.

18. The pressure regulating valve as claimed in claim 12, wherein the piston assembly divides the chamber into a first sub-chamber communicating with the inlet, and a second sub-chamber communicating with the outlet, and the first sub-chamber and the second sub-chamber communicate with each other.

19. The pressure regulating valve as claimed in claim 18, wherein the piston assembly further comprises a connecting member connecting the first piston with the second piston, and the connecting member has a passage communicating the first sub-chamber with the second sub-chamber.
